(19) United States
(12) Patent Application Publication
(10) Pub. No.: US 2026/0338577 A1
(43) Pub. Date: Oct. 29, 2026

(54) SYSTEMS AND METHODS TO RECOMMEND REMOTE OFFICES

(71) Applicant: Ford Global Technologies, LLC, Dearborn, MI (US)

(72) Inventors: Elias Montoya, Mexico City (MX); Israel Balderas, Hidalgo (MX); Nallely Martinez Perez, Iztapalapa (MX); Ramon Martinez, Nezahualcoyotl (MX); Maria Rossana Ruiz Castillo, Ypsilanti, MI (US)

(73) Assignee: Ford Global Technologies, LLC, Dearborn, MI (US)

(21) Appl. No.: 19/187,211

(22) Filed: Apr. 23, 2025

(51) Int. Cl. G01C 21/36; G06Q 10/1093

(52) U.S. Cl. CPC G01C 21/3691; G06Q 10/1093

(57) ABSTRACT

A vehicle that helps a user to identify a remote office on a route is disclosed. The vehicle may include a transceiver and a processor. The transceiver may receive a request from the user to activate a predefined vehicle mode. The processor may activate the vehicle mode responsive to obtaining the request. The processor may further determine that the user has an event scheduled at a predefined time based on calendar information associated with the user, responsive to activating the vehicle mode. The processor may additionally determine an estimated time of arrival (ETA) for the vehicle at a destination location, responsive to determining that the event is scheduled at the predefined time. The processor may further output a notification including information associated with the remote office located between a current vehicle location and the destination location, responsive to determining that the ETA is later than the predefined time.

### FIELD

The present disclosure relates to vehicles and more specifically to systems and methods to recommend remote offices on a vehicle route.

### BACKGROUND

Many users have hectic schedules, tasks, meetings, deadlines, etc. planned throughout their workday. If such tasks or meetings are scheduled early in the morning at the user's office, the user may find it difficult to reach the office on time due to rush hour morning traffic or because the user has to perform other activities before reaching the office (e.g., dropping kids to school).

In many such cases, the user may try to multitask while driving the vehicle to the office. For example, when the user knows that reaching the office on time for the meeting may not be possible, the user may sometimes join the meeting virtually and/or type and send an email or a message while driving the vehicle. Such instances may cause inconvenience to the user.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of a system to recommend a remote office to a user in accordance with the present disclosure.

FIG. 3 depicts an example first view of a vehicle Human-Machine Interface (HMI) in accordance with the present disclosure.

FIG. 4 depicts an example second view of a vehicle HM I in accordance with the present disclosure.

FIG. 5 depicts a flow diagram of an example method to recommend a remote office to a user in accordance with the present disclosure.

### DETAILED DESCRIPTION

### Overview

The present disclosure describes a vehicle that may identify and recommend one or more “remote offices” on a vehicle route to a user to temporarily work, e.g., when the user may be running late for a meeting or have an urgent deadline to meet or a pending task to complete.

The term “remote office”, as used in the present disclosure, may mean any location which may allow users to temporarily work. Examples of such remote offices include, but are not limited to, coffee shops, restaurants, shared office spaces, libraries, and/or the like.

It may be appreciated that often, users have meetings scheduled in the morning, have urgent deadlines to meet, or pending office tasks to complete. If such meetings and/or deadlines are scheduled for early morning, it may become difficult for the user to reach the user's office (or a “destination location”) on time due to rush hour morning traffic or because the user is required to perform one or more tasks before reaching the destination location (e.g., dropping the user's kids to the school). To support the user in such scenarios, the vehicle, as disclosed in the present disclosure, may identify and recommend one or more remote offices on the route between the user's home (or a “source location”) and the user's office, in which the user may halt and temporarily work (e.g., attend virtual meetings, type and send emails/messages, finish project work/presentations, etc.), before resuming the journey to the office. An example process implemented by the vehicle to identify and recommend a remote office on the vehicle route to the user is briefly described below.

In some aspects, the vehicle may first activate the vehicle's remote office locator mode when the user may be about to commence travel on the route to the destination location or while the user may already be traveling on the route. In an exemplary aspect, the vehicle may activate the remote office locator mode responsive to receiving an activation request from the user, via a user device or a vehicle Human-Machine Interface (HMI). Responsive to activating the remote office locator mode, the vehicle may fetch calendar information associated with the user from a server/cloud, after receiving user's authorization to fetch such information. In some aspects, the calendar information may include information associated with the user's scheduled meeting(s), deadlines, pending tasks, and/or the like, for the day, week, etc.

The vehicle may analyze the calendar information to check if the user has any event (e.g., a meeting) planned. Responsive to determining that the user may have an event planned at a predefined time (e.g., 8 AM) based on the calendar information, the vehicle may determine an estimated time of arrival (ETA) for the vehicle at the destination location. The vehicle may then compare the ETA with the predefined time for the event. The vehicle may identify one or more remote offices for the user on the route between the current vehicle location and the destination location, when the vehicle determines that the ETA is later than the predefined time. Stated another way, the vehicle may identify a remote office for the user when the vehicle determines that the user may be running late and may not be able to reach the destination location (or the user's office) by the time of the scheduled event/meeting. In additional aspects, the vehicle may identify remote offices that may not be 100% or fully aligned with the route between the current vehicle location and the destination location, and may require slight deviation from the route (e.g., which may require the user to take a detour of a few miles). In this case, the identified remote offices may be within a predefined distance range tolerance (e.g., up to 3 miles or 5 miles), that may be preset by the user. In some aspects, the vehicle may additionally provide/output a toggle option to the user, e.g., “Show office options along main route only” as YES or NO, and the vehicle may identify the remote offices for the user based on the user's selection of the toggle option.

Responsive to identifying the remote office(s), the vehicle may output a notification on the user device and/or the vehicle HMI, including information associated with the remote office(s). Examples of such information include, but are not limited to, a geolocation associated with the remote office, an estimated travel time from the current vehicle location to the remote office, user ratings or feedback associated with the remote office, information associated with the amenities at the remote office, parking availability at the remote office, and/or the like. In an exemplary aspect, the notification may include information associated with other user's ratings for each remote office, availability of in-house parking or street parking, handicap parking availability or street parking, distance from vehicle's current location, an Artificial Intelligence (AI) powered ranking based on the information described above to output an overall score associated with the remote office to the user to help the user in making an informed decision when selecting a remote office to work, and/or the like.

The user may view/hear the notification, select a remote office to work based on the information included in the notification, and then accept to travel to the selected remote office. Responsive to obtaining the user acceptance, the vehicle may navigate (e.g., autonomously navigate or facilitate the user to drive) from the vehicle's current location to the geolocation associated with the remote office. Upon reaching the remote office, the user may work from the remote office (e.g., attend the meeting virtually at 8 AM) . If the remote office selected by the user requires deviation from the original route, the vehicle may additionally offer a re-route function to route the user from the remote office to the destination location.

In this manner, the vehicle helps the user to meet the user's official commitments by working from a remote office on the route to the user's office, without having to miss any deadlines or scheduled meetings and without having to multitask from the vehicle or work from the vehicle. The vehicle may further “learn” the user's travel pattern, the remote office selection behavior, typical office timings, meetings schedules, user preferences, etc. over time, and may recommend optimized daily travel plans to the user before the user commences the journey on the route every morning.

In some aspects, the vehicle may provide additional features to the user that may enhance the user's experience of operating the vehicle. For example, when the vehicle determines that the user may have overlapping or conflicting meetings at substantially the same time based on the calendar information, the vehicle may request (via the HMI or the user device) that the user confirms which meeting the user desires to attend (or confirms the priority of meetings for the user). Based on the user's response, the vehicle may determine the meeting that the user may attend and accordingly perform the process of identifying the remote office(s) for the user.

In further aspects, responsive to activating the remote office locator mode, the vehicle may automatically synchronize with the user's email and instant messenger (IM) app or account and change their status to “Driving” to inform others that the user is driving the vehicle and hence may not immediately be able to respond to emails and messages or attend a meeting until the vehicle is stopped.

The present disclosure discloses a vehicle that identifies one or more optimal remote offices in which the user may halt and temporarily work, while traveling to the user's office. By working at the remote office on the route, the user is not required to multitask from the vehicle and the probability of the user missing any official commitment considerably decreases. Over time, the vehicle further learns from the user's behavior and travel patterns how to better recommend customized daily plans for travel and work, significantly enhancing the user's convenience and planning for the day.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

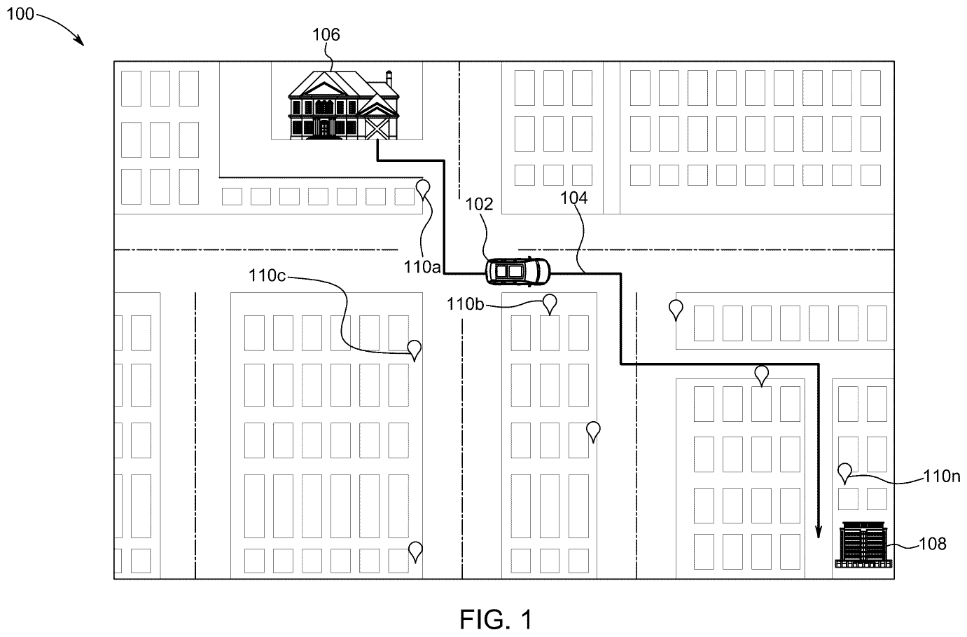

FIG. 1 depicts an example environment 100 in which techniques and structures for providing the systems and methods disclosed herein may be implemented. The environment 100 may include a vehicle 102, which may be traveling (or about to commence travel) on a vehicle route 104. In an exemplary aspect, the route 104 may start from a user's source location 106 (which may be, for example, the user's home) and end at a destination location 108 (which may be, for example, the user's office, a scheduled meeting location or any scheduled event's location).

The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. Further, the vehicle 102 may include any powertrain, such as a gasoline engine, one or more electrically-actuated motor(s), or a hybrid system.

In an exemplary aspect, a vehicle 102 owner/user (“user”, not shown) may have an event scheduled at a predefined time (e.g., at 8 AM), for which the user may be traveling (or about to commence travel) on the route 104 via the vehicle 102. Examples of the event include, but are not limited to, a scheduled meeting at the destination location 108, a deadline or a pending task that needs to be finished/delivered by the predefined time, and/or the like.

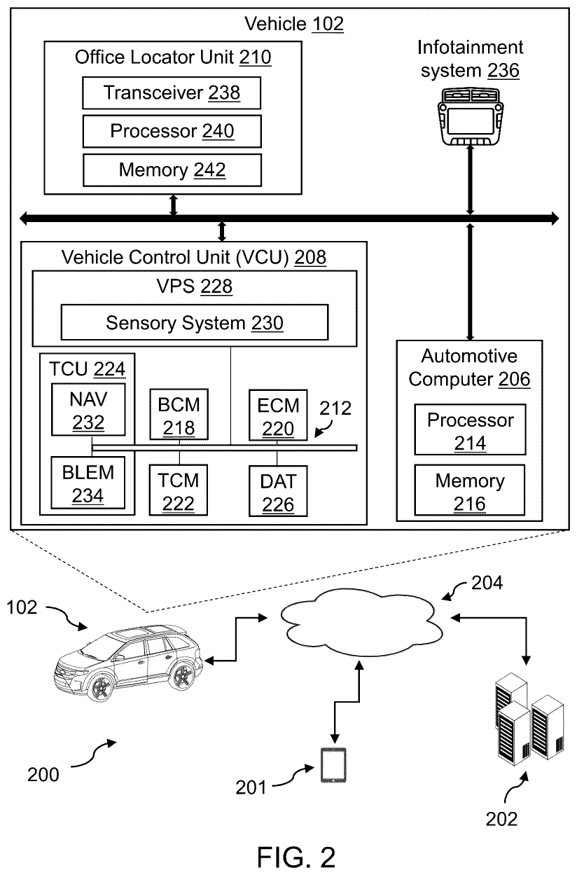

It may be appreciated that when such events are scheduled in the morning, it may become difficult for the user to reach the destination location 108 on time due to rush hour morning traffic or because the user is required to perform one or more tasks before reaching the destination location 108 (e.g., dropping the user's kids to the school). To support the user in such scenarios, the vehicle 102 may identify and recommend one or more “remote offices” on the route 104 between the source location 106 and the destination location 108, in which the user may halt and temporarily work (e.g., attend virtual meetings, type and send emails/messages, finish project work/presentations, etc.), before resuming the journey to the destination location 108. The term “remote office”, as used in the present disclosure, may mean any location that may allow users to temporarily work. Examples of such remote offices include, but are not limited to, coffee shops, restaurants, shared office spaces, libraries, and/or the like. An example process implemented by the vehicle 102 to identify and recommend a remote office on the route 104 to the user is briefly described below and described in detail later in conjunction with FIG. 2.

In some aspects, the vehicle 102 may first activate a predefined vehicle mode (e.g., a “remote office locator mode”) when the user enters the vehicle 102 and is about to commence the journey on the route 104. In other aspects, the vehicle 102 may activate the remote office locator mode when the vehicle 102 may already be traveling on the route 104. The vehicle 102 may activate the remote office locator mode responsive to obtaining an activation request from the user via, e.g., a user device (shown as user device 201 in FIG. 2), a vehicle Human-Machine Interface (HMI, shown as HMI 236 in FIG. 2), voice command, gesture command, and/or the like. As an example, the user may transmit the activation request to the vehicle 102 whenever the user is running late for the event described above and may require the vehicle's assistance in identifying a remote office for the user on the route 104.

Responsive activating the remote office locator mode, the vehicle 102 may obtain calendar information associated with the user (or the user's schedule) from a server (shown as server 202 in FIG. 2). The calendar information may include information associated with the user's scheduled meeting(s), deadlines, pending tasks, and/or the like, for the day, week, etc. In some aspects, the vehicle 102 may fetch the user's calendar information from the server responsive to obtaining the user's confirmation/authorization.

The vehicle 102 may then determine that the user may have an event (e.g., a meeting) scheduled at the predefined time (e.g., at 8 AM) based on the obtained calendar information. The vehicle 102 may further determine an estimated time of arrival (ETA) for the vehicle 102 at the destination location 108 based on one or more parameters, such as a distance between a current vehicle location (which may be the same as or different from the source location 106, depending on when the user transmits the activation request to the vehicle 102) and the destination location 108, the real-time traffic information associated with the traffic on the route 104, the weather information associated with the route 104, road grade information, and/or the like.

The vehicle 102 may then compare the ETA with the predefined time (e.g., the scheduled meeting's time). The vehicle 102 may commence to identify one or more remote offices on the route 104 for the user between the current vehicle location and the destination location 108 when the ETA may be later than the predefined time. For example, the vehicle 102 may commence to identify the remote office(s) on the route 104 for the user when the ETA may be 8:30 AM and the predefined time may be 8 AM. It may be appreciated that in this case, the user may not be able to reach the destination location 108 or the user's office at the time of the scheduled meeting and may hence be required to attend the meeting virtually while sitting in a remote office.

To identify one or more optimal remote offices on the route 104 for the user, the vehicle 102 may first identify a plurality of remote offices 110a, 110b, 110c, 110n (collectively referred to as remote offices 110) that may be located in (or in proximity to) the route 104 between the current vehicle location and the destination location 108. The vehicle 102 may then identify one or more optimal remote offices (from the remote offices 110) to recommend to the user based on one or more parameters, such as user's historical selection of remote offices, user preferences, historical user travel pattern, a distance between the remote office and the current vehicle location, an estimated travel time from the current vehicle location to the remote office, user ratings or feedback associated with the remote office, information associated with the amenities at the remote office, parking availability at the remote office, the predefined time (i.e., 8 AM) for the event/meeting, and/or the like. As an example, the vehicle 102 may identify the remote offices 110a and 110b to be the optimal remote offices for the user, as these offices may have available parking, and the user may reach these offices before 8 AM (and may hence easily attend the scheduled meeting virtually). As another example, the vehicle 102 may identify the remote offices 110a and 110b to be the optimal remote offices for the user, if the user preferences indicate that the user prefers a remote office with more than three star rating (out of five), and these offices have more than three star ratings. As yet another example, the vehicle 102 may identify the remote office 110a as the optimal remote office for the user if the user has historically selected and worked at this office and provided good feedback/rating to this office.

In some aspects, it is not necessary that the optimal remote office(s) identified by the vehicle 102 are always on the route 104. In an exemplary aspect, the vehicle 102 may identify the remote office 110c as the optimal remote office for the user (even though the remote office 110c requires deviation from the route 104), based on the parameters described above. For example, the vehicle 102 may identify the remote office 110c as the optimal remote office for the user if the user has previously worked in this office and has liked the services offered by the office. In some aspects, the user may preset on the vehicle 102 a “distance tolerance” or “detour tolerance” from the route 104 that the user is willing to accept when selecting the remote office to work.

Responsive to identifying the optimal remote office(s) (e.g., the remote offices 110a, 110b) for the user, the vehicle 102 may output a notification on the user device or the vehicle HMI, including information associated with the identified optimal remote offices 110a, 110b. This information may include, for example, geolocations associated with the remote offices 110a, 110b, estimated travel times from the current vehicle location to the respective remote offices 110a, 110b, user ratings or feedback associated with each remote office 110a, 110b, information associated with the amenities at each remote office 110a, 110b, parking availability at each remote office 110a, 110b, and/or the like. In an exemplary aspect, the notification may include information associated with other user's ratings for each remote office 110a, 110b, availability of in-house parking or street parking, handicap parking availability or street parking, distance from the vehicle's current location, an AI-powered ranking based on the information described above to output an overall score associated with the remote office 110a, 110b to the user to help the user in making an informed decision when selecting a remote office to work, and/or the like. In another exemplary aspect, the remote offices may be evaluated according to the suitability for a given task (e.g. a busy coffee shop may be an appropriate location for the user to send an urgent e-mail but dedicated conference room in shared workspace may be required if the user needs to be actively engaged in a meeting) and the recommendation may take that into account.

The user may view/hear this information and may select (or accept) traveling to one of the recommended remote offices (e.g., the remote office 110a) to work. In an exemplary aspect, the user may select/accept the remote office 110a by providing a voice command or a gesture command to the vehicle 102.

In some aspects, responsive to receiving the user selection of the remote office 110a, the vehicle 102 may output navigation instructions on the user device or the vehicle HMI, to facilitate user navigation from the current vehicle location to the remote office 110a. In other aspects, responsive to receiving the user selection of the remote office 110a, the vehicle 102 may autonomously navigate from the current vehicle location to the remote office 110a. Upon reaching the remote office 110a, the user may work from the remote office 110a (e.g., attend the meeting virtually at 8 AM) . If the remote office selected by the user requires deviation from the original route 104 (e.g., if the user selects the remote office 110c to work), the vehicle 102 may additionally offer a re-route function to route the user from the remote office 110c to the destination location 108.

In this manner, the vehicle 102 helps the user to meet the user's official commitments by working from a remote office on the route 104, without having to miss any deadlines or scheduled meetings and without having to multitask from the vehicle 102 or work from the vehicle 102. Over time, the vehicle 102 may further “learn” the user's travel patterns, the remote office selection behavior, typical office timings, meetings schedules, user preferences, etc., and may recommend optimized daily travel plans to the user before the user commences the journey on the route 104 every morning. For example, the vehicle 102 may use Artificial Intelligence (AI) to learn the parameters described above over time, and recommend a daily plan to the user which may include leaving the source location 106 at 7:30 AM, reaching the remote office 110a at 7:50 AM, attending a scheduled meeting at 8 AM at the remote office 110a, leaving the remote office 110a at 8:45 AM, picking up coffee at 9 AM from a coffee shop located between the remote office 110a and the destination location 108, and reaching the destination location 108 at 9:20 AM (e.g., to attend another meeting scheduled at 9:30 AM at the destination location 108), and/or the like.

In some aspects, the vehicle 102 may provide additional features to the user that may enhance the user's experience of operating the vehicle 102. For example, when the vehicle 102 determines that the user may have overlapping or conflicting meetings at substantially the same time based on the calendar information, the vehicle 102 may request (via the HMI or the user device) that the user confirms which meeting the user desires to attend (or confirms the priority of meetings for the user). Based on the user's response, the vehicle 102 may determine the meeting that the user may attend and accordingly perform the process of identifying the remote office for the user.

In further aspects, responsive to activating the remote office locator mode, the vehicle 102 may automatically synchronize with the user's email and instant messenger app or account and change their status to “Driving” to inform others that the user is driving the vehicle 102 and hence may not be able to immediately respond to emails and messages or attend a meeting until the vehicle 102 is stopped.

Further vehicle 102 details are described below in conjunction with FIG. 2.

The vehicle 102 implements and/or performs operations, as described here in the present disclosure, in accordance with the owner manual and safety guidelines. In addition, any action taken by the user based on the notifications provided by the vehicle 102 should comply with all the rules specific to the location and operation of the vehicle 102 (e.g., Federal, state, country, city, etc.). The notifications, as provided by the vehicle 102, should be treated as suggestions and only followed according to any rules specific to the location and operation of the vehicle 102.

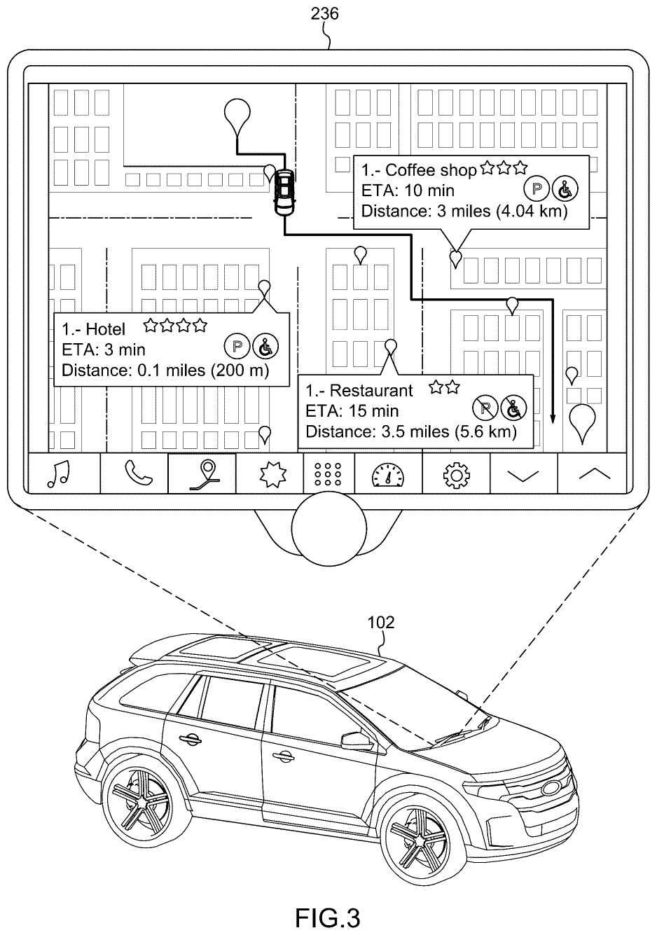

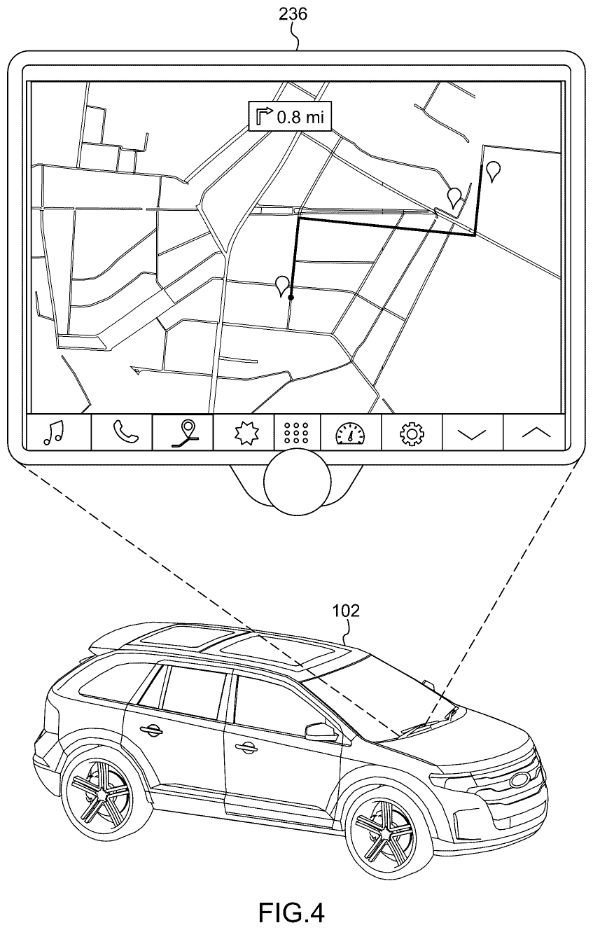

FIG. 2 depicts a block diagram of a system 200 to recommend a remote office to a user in accordance with the present disclosure. While describing FIG. 2, references will be made to FIGS. 3 and 4.

The system 200 may include the vehicle 102, a user device 201 and one or more servers 202 (or a server 202) that may be communicatively coupled with each other via one or more networks 204. The user device 201 may be associated with the vehicle owner/user, and may be, for example, a mobile phone, a laptop, a computer, a tablet, a smartwatch, or any other similar device with communication capabilities. The server 202 may be part of a cloud-based computing infrastructure and may be associated with and/or include a Telematics Service Delivery Network (SDN) that provides digital data services to the vehicle 102 and other vehicles (not shown in FIG. 2) that may be part of a vehicle fleet. In further aspects, the server 202 may store the calendar information associated with the user and may transmit the calendar information to the vehicle 102 when the vehicle 102 transmits a request to the server 202 to obtain such information. As described above, the calendar information may include information associated with the user's scheduled meeting(s), deadlines, pending tasks, and/or the like, for the day, week, etc.

The server 202 may further store real-time traffic information, map or navigation information, weather information, road grade information, and/or the like, associated with the route 104. The server 202 may additionally store information associated with the plurality of remote offices 110, e.g., their geolocations, user ratings or feedback associated with each remote office 110, information associated with the amenities at each remote office 110, real-time parking availability at each remote office 110, and/or the like. The server 202 may transmit such route-related information and remote office related information to the vehicle 102 at a predefined frequency or when the vehicle 102 transmits a request to the server 202 to obtain such information.

The network(s) 204 illustrates an example of communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDM A), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 102 may include a plurality of units including, but not limited to, an automotive computer 206, a Vehicle Control Unit (VCU) 208 and an office locator unit 210 (or unit 210). The VCU 208 may include a plurality of Electronic Control Units (ECUs) 212 in communication with the automotive computer 206.

In some aspects, the automotive computer 206 and/or the unit 210 may be installed anywhere in the vehicle 102, in accordance with the disclosure. Further, the automotive computer 206 may operate as a functional part of the unit 210. The automotive computer 206 may be or include an electronic vehicle controller, having one or more processors(s) 214 and a memory 216. Moreover, the unit 210 may be separate from the automotive computer 206 (as shown in FIG. 2) or may be integrated as part of the automotive computer 206.

The processor(s) 214 may be in communication with one or more memory devices in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable medium or memory storing a remote office locator program code. The memory 216 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 208 may share a power bus with the automotive computer 206 and may be configured and/or programmed to coordinate the data between vehicle 102 systems, connected servers (e.g., the server(s) 202), the user device 201 and other vehicles (not shown in FIG. 2) operating as part of a vehicle fleet. The VCU 208 may include or communicate with any combination of the ECUs 212, such as a Body Control Module (BCM) 218, an Engine Control Module (ECM) 220, a Transmission Control Module (TCM) 222, a Telematics Control Unit (TCU) 224, a Driver Assistances Technologies (DAT) controller 226, etc.

The VCU 208 may further include and/or communicate with a Vehicle Perception System (VPS) 228, having connectivity with and/or control of one or more vehicle sensory system(s) 230 (or a “sensor unit”). The vehicle sensory system 230 may include one or more vehicle sensors including, but not limited to, a radio detection and ranging (radar) sensor configured for detection and localization of objects inside and outside the vehicle 102 using radio waves, sitting area buckle sensors, sitting area sensors, a light detecting and ranging (lidar) sensor, door sensors, proximity sensors, temperature sensors, wheel sensors, ambient weather sensors, ambient light sensors, vehicle interior and exterior cameras, one or more rain sensors, a humidity sensor, a tire pressure sensor, ultrasonic sensors, one or more microphones, etc.

In some aspects, the VCU 208 may control vehicle operational aspects and implement one or more instruction sets received from the user device 201, from one or more instruction sets stored in the memory 216, including instructions operational as part of the unit 210.

The TCU 224 may provide vehicle connectivity to wireless computing systems onboard and off board the vehicle 102 and may include a Navigation (NAV) receiver 232 for receiving and processing a GPS signal, a BLE Module (BLEM) 234, a Wi-Fi transceiver, a UWB transceiver, and/or other wireless transceivers (not shown in FIG. 2) that may be configurable for wireless communication (including cellular communication) between the vehicle 102 and other systems (e.g., the user device 201, a key fob, an NFC device, etc.), computers, and modules. The NAV receiver 232 may be configured to determine a real-time vehicle geolocation. The TCU 224 may be in communication with the ECUs 212 by way of a bus.

The ECUs 212 may control aspects of vehicle operation and communication using inputs from human drivers, inputs from an autonomous vehicle controller, the unit 210, and/or via wireless signal inputs received via the wireless connection(s) from other connected devices, such as the user device 201, the server(s) 202, among others.

The BCM 218 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, and/or the like. The BCM 218 may also operate as a gateway for bus and network interfaces to interact with remote ECUs (not shown in FIG. 2).

The DAT controller 226 may provide Level-1 through Level-3 automated driving and driver assistance functionality that may include, for example, active parking assistance, vehicle backup assistance, and adaptive cruise control, among other features. The DAT controller 226 may also provide aspects of user and environmental inputs that are usable for user authentication.

In some aspects, the automotive computer 206 may connect with an infotainment system 236 (or a vehicle Human-Machine Interface (HMI) 236). The infotainment system 236 may include a touchscreen interface portion and may include voice recognition features, biometric identification capabilities that can identify users based on facial recognition, voice recognition, fingerprint identification, or other biological identification means. In other aspects, the infotainment system 236 may further receive user instructions/inputs via the touchscreen interface portion and/or display notifications/recommendations, navigation maps, etc. on the touchscreen interface portion.

The computing system architecture of the automotive computer 206, the VCU 208, and/or the unit 210 may omit certain computing modules. It should be readily understood that the computing environment depicted in FIG. 2 is an example of a possible implementation according to the present disclosure, and thus, it should not be considered limiting or exclusive.

In accordance with some aspects, the unit 210 may be integrated with and/or executed as part of the ECUs 212. The unit 210, regardless of whether it is integrated with the automotive computer 206 or the ECUs 212, or whether it operates as an independent computing system in the vehicle 102, may include a transceiver 238, a processor 240, and a computer-readable memory 242.

The transceiver 238 may receive information/inputs from one or more external devices or systems, e.g., the user device 201, the server(s) 202, and/or the like via the network 204. For example, the transceiver 238 may receive the user's calendar information, the route related information, the remote office related information, and/or the like, from the server 202 via the network 204. The transceiver 238 may further transmit notifications/data/signals to the external devices or systems. In addition, the transceiver 238 may receive information/inputs from vehicle 102 components such as the infotainment system 236, the VCU 208 (e.g., the vehicle sensory system 230), and/or the like. Further, the transceiver 238 may transmit notifications/command signals to the vehicle 102 components such as the VCU 208, the infotainment system 236, the BCM 218, etc.

The processor 240 and the memory 242 may be the same as or similar to the processor 214 and the memory 216, respectively. In some aspects, the processor 240 may utilize the memory 242 to store programs in code and/or to store data for performing aspects in accordance with the disclosure. The memory 242 may be a non-transitory computer-readable medium or memory storing the remote office locator program code.

In operation, the transceiver 238 may first receive a request from the user to activate the vehicle's remote office locator mode, when the user desires the vehicle 102 to identify a remote office for the user on the route 104. The user may transmit the request to the transceiver 238 via the user device 201 or the HMI 236. In some aspects, the user may transmit the request to the transceiver 238 before entering the vehicle 102, when the user just enters the vehicle 102, or while the vehicle 102 is already traveling on the route 104. In this manner, the user may request the vehicle 102 to activate the remote office locator mode before commencing travel on the route 104 or while the vehicle 102 is traveling on the route 104.

The transceiver 238 may transmit the request to the processor 240. The processor 240 may activate the vehicle's remote office locator mode responsive to obtaining the request. Responsive to activating the remote office locator mode, the processor 240 may transmit or output (via the transceiver 238) a calendar information request on the user device 201 and/or the HMI 236. The calendar information request may be a request to obtain user's confirmation or authorization to fetch the user's calendar information from the server 202. The user may view/hear the calendar information request on the user device 201 and/or the HMI 236 and may accordingly provide the user's consent or confirmation to fetch the user's calendar information from the server 202.

The processor 240 may obtain the user's confirmation (via the transceiver 238) on the calendar information request and then fetch (via the transceiver 238) the user's calendar information from the server 202 responsive to obtaining the confirmation. The processor 240 may check the user's calendar information to determine that an event (e.g., a meeting) may be scheduled at a predefined time (e.g., at 8 AM) for the user based on the calendar information, as described above in conjunction with FIG. 1. Responsive to determining that an event may be scheduled at the predefined time, the processor 240 may determine an ETA for the vehicle 102 at the destination location 108 (which may be the user's office or event location). In some aspects, the processor 240 may determine the ETA at the destination location 108 based on the route related information obtained from the server 202. Examples of such information include, but are not limited to, the distance between the current vehicle location (determined via the TCU 224) and the destination location 108, the real-time traffic information on the route 104, weather information associated with the route 104, and/or the like.

Responsive to determining the ETA, the processor 240 may compare the ETA with the predefined time for the event (e.g., 8 AM) . In some aspects, the processor 240 may commence to identify one or more optimal remote offices (from the plurality of remote offices 110) on the route 104 between the current vehicle location and the destination location 108 in which the user may temporarily work, when the processor 240 determines that the ETA is later than the predefined time. Stated another way, the processor 240 may commence to identify the optimal remote office(s) for the user when the processor 240 determines that the user may be running late and may not be able to reach the destination location 108 by the time of the scheduled meeting/event. An example process implemented by the processor 240 to identify the optimal remote office(s) for the user is described below.

The processor 240 may first identify all the remote offices (e.g., the plurality of remote offices 110) that may be located between the current vehicle location and the destination location 108 on or in proximity to the route 104, based on the route and/or remote office related information obtained from the server 202. The processor 240 may then identify or select one or more optimal remote offices (e.g., the remote offices 110a, 110b) for the user from the plurality of remote offices 110, based on one or more parameters including, but not limited to, user's historical selection of remote offices on the route 104, user preferences, historical user travel pattern, a distance between the optimal remote office and the current vehicle location, an estimated travel time from the current vehicle location to the optimal remote office, user ratings or feedback associated with the optimal remote office, information associated with the amenities at the optimal remote office, the parking availability at the optimal remote office, the predefined time of the scheduled event/meeting, and/or the like.

Responsive to identifying/selecting the optimal remote office(s) for the user as described above, the processor 240 may output (via the transceiver 238) a notification including information associated with the optimal remote office(s) on the user device 201 and/or the HMI 236. The information associated with the optimal remote office(s) that may be displayed on the user device 201 and/or the HMI 236 may include, for example, the name and type of the remote office, a geolocation associated with the remote office, an estimated travel time from the current vehicle location to the remote office, a distance of the remote office from the current vehicle location, user ratings or feedback associated with the remote office, information associated with the amenities at the remote office, in-house parking availability at the remote office, handicap parking availability at the remote office, and/or the like. An example view of the HMI 236 displaying the information associated with the remote office is depicted in FIG. 3.

The user may view/hear the notification on the user device 201 and/or the HMI 236, and may select a remote office (e.g., the remote office 110a) in which the user may desire to temporarily work on the route 104, based on the information displayed on the notification. The user may select the remote office 110a via a voice command or a gesture, or by manually clicking on a location icon associated with the remote office 110a on the user device 201 and/or the HMI 236. Responsive to the user selecting the remote office 110a, the processor 240 may obtain a user acceptance to travel to the remote office 110 (e.g., via the user device 201 and/or the HMI 236). The processor 240 may then output navigation instructions on the user device 201 and/or the HMI 236 (as shown in FIG. 4), which may help the user to drive the vehicle 102 from the current vehicle location to the geolocation associated with the remote office 110a. In other aspects, responsive to obtaining the user acceptance, the processor 240 may autonomously navigate the vehicle 102 from the current vehicle location to the geolocation associated with the remote office 110a.

Upon reaching the remote office 110a, the user may complete the office work (e.g., attend the scheduled meeting virtually) from the remote office 110a, and then resume the journey to the destination location 108. If the remote office selected by the user to work requires deviation from the original route 104, the processor 240 may additionally offer a re-route function to route the user from the remote office to the destination location 108.

In this manner, the vehicle 102 helps the user to meet the user's official commitments by working from a remote office on the route 104, without having to miss any deadlines or scheduled meetings and without having to multitask from the vehicle 102 or work from the vehicle 102.

It may be appreciated that since the user can activate the vehicle's remote office locator mode before commencing the journey on the route 104 or anytime while traveling on the route 104 (as described above), the processor 240 may identify the remote office(s) for the user and output notification associated with the identified remote office(s) before the vehicle 102 commences travel on the route 104 or anytime the vehicle 102 is traveling on the route 104.

In further aspects, the processor 240 may be an AI-based processor that may analyze the user data over time (e.g., user's calendar events, selected remote offices, travel patterns, preferences, etc.) to learn user routines, predict future needs and suggest/recommend personalized daily plans, as described above in conjunction with FIG. 1. The processor 240 may recommend such personalized daily plans irrespective of whether the user has scheduled meetings, deadlines, etc., or not. If no meetings are scheduled before the arrival time at the destination location 108, the processor 240 may suggest locations for completing work-related tasks during the commute or near the destination location 108, based on the AI-generated daily plan and user preferences. The Al algorithm may continuously learn from the user choices, feedback, and travel patterns, refining its daily plan suggestions and enhancing its accuracy over time.

Although the present disclosure is described in the context of office-going users, the teachings of the present disclosure may also be applied in the context of other users with similar requirements, e.g., truck drivers who may need one or more resting places on their travel routes.

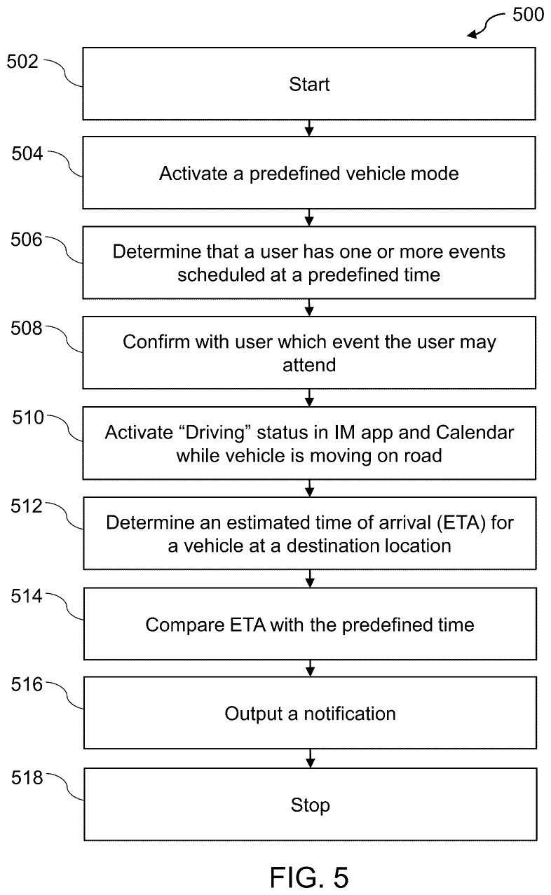

FIG. 5 depicts a flow diagram of an example method 500 to recommend a remote office to a user in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include activating, by the processor 240, the vehicle's remote office locator mode responsive to obtaining the activation request from the user. At step 506, the method 500 may include determining, by the processor 240, that the user has one or more events scheduled at a predefined time or through the day based on the calendar information obtained from the server 202, responsive to activating the remote office locator mode.

At step 508, the method 500 may include confirming, by the processor 240, from the user which event the user may attend at the predefined time (or through the day). At step 510, the method 500 may include activating, by the processor 240, a “Driving” status on the user's email and/or instant messenger app or account or changing their status to “Driving” while the vehicle 102 is moving on the road. This may inform others that the user is driving the vehicle 102 and hence may not be able to immediately respond to emails and messages or attend a meeting until the vehicle 102 is stopped.

At step 512, the method 500 may include determining, by the processor 240, the ETA for the vehicle 102 at the destination location 108, responsive to determining that the user has the event scheduled at the predefined time or responsive to receiving the user selection of the event that the user may attend at the predefined time. At step 514, the method 500 may include comparing, by the processor 240, the ETA with the predefined time. At step 516, the method 500 may include outputting, by the processor 240, the notification including the information associated with the identified optimal remote office located between the current vehicle location and the destination location 108, responsive to determining that the ETA is later than the predefined time.

At step 518, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. M any embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle comprising:
a transceiver configured to receive a request from a user to activate a predefined vehicle mode; and
a processor configured to:
activate the predefined vehicle mode responsive to obtaining the request;
determine that the user has an event scheduled at a predefined time based on a calendar information associated with the user;
determine an estimated time of arrival for the vehicle at a destination location on a vehicle route;
compare the estimated time of arrival with the predefined time; and
responsive to determining that the estimated time of arrival is later than the predefined time, output a notification comprising an information associated with a remote office located between a current vehicle location and the destination location, wherein the remote office is a location in which the user may temporarily work.

2. The vehicle of claim 1, wherein the transceiver receives the request from the user via a user device or a vehicle Human-Machine Interface (HMI).

3. The vehicle of claim 1, wherein the transceiver is further configured to receive the calendar information associated with the user from a server.

4. The vehicle of claim 3, wherein the processor is further configured to:
output a calendar information request responsive to activating the predefined vehicle mode;
obtain a confirmation from the user responsive to outputting the calendar information request; and
obtain the calendar information from the server responsive to obtaining the confirmation.

5. The vehicle of claim 1, wherein the event is at least one of: a scheduled meeting, a deadline, or a pending task.

6. The vehicle of claim 1, wherein the destination location is at least one of: a user's office location or an event location.

7. The vehicle of claim 1, wherein the processor determines the estimated time of arrival at the destination location based on at least one of: a distance between the current vehicle location and the destination location, real-time traffic information, or weather information.

8. The vehicle of claim 1, wherein the processor outputs the notification on a user device or a vehicle Human-Machine Interface (HMI).

9. The vehicle of claim 1, wherein the information associated with the remote office comprises at least one of: a geolocation associated with the remote office, an estimated travel time from the current vehicle location to the remote office, user ratings or feedback associated with the remote office, information associated with amenities at the remote office, or parking availability at the remote office.

10. The vehicle of claim 1, wherein the processor is further configured to:
identify a plurality of remote offices located between the current vehicle location and the destination location;
select the remote office from the plurality of remote offices; and
output the notification responsive to selecting the remote office.

11. The vehicle of claim 10, wherein the processor selects the remote office based on at least one: user's historical selection of remote offices, user preferences, historical user travel pattern, a distance between the remote office and the current vehicle location, an estimated travel time from the current vehicle location to the remote office, user ratings or feedback associated with the remote office, information associated with amenities at the remote office, parking availability at the remote office, or the predefined time.

12. The vehicle of claim 1, wherein the processor is further configured to:
obtain a user acceptance to travel to the remote office responsive to outputting the notification; and
navigate the vehicle from the current vehicle location to a geolocation associated with the remote office responsive to obtaining the user acceptance.

13. The vehicle of claim 1, wherein the processor outputs the notification before the vehicle commences travel on the vehicle route.

14. The vehicle of claim 1, wherein the processor outputs the notification while the vehicle is traveling on the vehicle route.

15. A method comprising:
activating, by a processor, a predefined vehicle mode associated with a vehicle responsive to obtaining a request from a user to activate the predefined vehicle mode;
determining, by the processor, that the user has an event scheduled at a predefined time based on a calendar information associated with the user;
determining, by the processor, an estimated time of arrival for the vehicle at a destination location on a vehicle route;
comparing, by the processor, the estimated time of arrival with the predefined time; and
responsive to determining that the estimated time of arrival is later than the predefined time, outputting, by the processor, a notification comprising an information associated with a remote office located between a current vehicle location and the destination location, wherein the remote office is a location in which the user may temporarily work.

16. The method of claim 15 further comprising:
outputting a calendar information request responsive to activating the predefined vehicle mode;
obtaining a confirmation from the user responsive to outputting the calendar information request; and
obtaining the calendar information from a server responsive to obtaining the confirmation.

17. The method of claim 15, wherein the event is at least one of: a scheduled meeting, a deadline, or a pending task.

18. The method of claim 15, wherein the destination location is at least one of: a user's office location or an event location.

19. The method of claim 15, wherein determining the estimated time of arrival comprises determining the estimated time of arrival based on at least one of: a distance between the current vehicle location and the destination location, real-time traffic information, or weather information.

20. A non-transitory computer-readable storage medium having instructions stored thereupon which, when executed by a processor, cause the processor to:
activate a predefined vehicle mode associated with a vehicle responsive to obtaining a request from a user to activate the predefined vehicle mode;
determine that the user has an event scheduled at a predefined time based on a calendar information associated with the user, responsive to activating the predefined vehicle mode;
determine an estimated time of arrival for the vehicle at a destination location on a vehicle route, responsive to determining that the user has the event scheduled at the predefined time;
compare the estimated time of arrival with the predefined time; and
responsive to determining that the estimated time of arrival is later than the predefined time, output a notification comprising an information associated with a remote office located between a current vehicle location and the destination location, wherein the remote office is a location in which the user may temporarily work.
